(19) United States
(12) Patent Application Publication
(10) Pub. No.: US 2024/0370764 A1
(43) Pub. Date: Nov. 7, 2024

(54) GENERATIVE MACHINE LEARNING FRAMEWORK

(71) Applicant: ServiceNow, Inc., Santa Clara, CA (US)

(72) Inventors: Gaurav Goyal, San Jose, CA (US); Prashanti Nilayam, San Jose, CA (US)

(21) Appl. No.: 18/142,966

(22) Filed: May 3, 2023

(51) Int. Cl. G06N 20/00

(52) U.S. Cl. CPC G06N 20/00

(57) ABSTRACT

A framework is provided for accessing one or more generative machine learning services. A specification of a desired solution associated with at least one of the one or more generative machine learning services is received in a first format of the framework. The specification is preprocessed to generate a request in a second format of a selected generative machine learning service among the one or more generative machine learning services. A result of the selected generative machine learning service is received in response to the request. The result of the selected generative machine learning service is postprocessed, wherein the preprocessing of the specification or the postprocessing of the result applies a configuration of the framework. At least a portion of the postprocessed result is provided in response to the received specification of the desired solution.

### BACKGROUND OF THE INVENTION

Generative AI and Large Language Models (LLMs) offer functionality to receive and predict human language in response to a received request. LLMs in particular are trained on large sets of human language input data such as documents, articles, books, and websites. To apply the trained LLM to predict human language, the LLM is typically supplied with tuning parameters and a request prompt. By varying the tuning parameters and prompt, different predicted results can be generated.

### BRIEF DESCRIPTION OF THE DRAWINGS

Various embodiments of the invention are disclosed in the following detailed description and the accompanying drawings.

FIG. 1 is a block diagram illustrating an embodiment of a generative machine learning framework for integrating AI services.

FIG. 2 is a block diagram illustrating an embodiment of a cloud service with a generative machine learning framework for integrating AI services.

FIG. 3 is a flow chart illustrating an embodiment of a process for integrating AI services with a cloud service using a machine learning framework.

FIG. 4 is a flow chart illustrating an embodiment of a process for installing support for an AI service using a machine learning framework.

FIG. 5 is a flow chart illustrating an embodiment of a process for configuring an AI service to support AI service solutions.

FIG. 6 is a flow chart illustrating an embodiment of a process for providing an AI enhanced solution for a cloud service request.

FIG. 7 is a flow chart illustrating an embodiment of a process for requesting an AI enhanced solution using local context data.

FIG. 8 is a functional diagram illustrating a programmed computer system for a generative machine learning framework for integrating AI services.

FIG. 9 is a diagram illustrating an embodiment of a user interface for a virtual agent cloud service integrated with an AI service using a generative machine learning framework.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A generative machine learning framework is disclosed. Using the disclosed machine learning framework and platform, cloud-based solutions can be provided that utilize Artificial Intelligence (AI) services and in particular that integrate generative AI and trained Large Learning Models (LLMs). The AI services can be integrated with the cloud service using a machine learning framework allowing the cloud services to support and provide enhanced AI results. For example, a cloud service can offer a cloud-based solution for creating and implementing digital workflows such as Information Technology ticketing systems, travel scheduling, and Human Resource processes, among others. Using the disclosed framework, generative AI services including third-party machine learning services can be integrated into the created workflows. For example, text documents including chat logs generated using virtual agents and incident reports submitted by users can be summarized using an AI summary service. As another example, search results based on the local context of the user's search request can be enhanced with AI search functionality by providing enhanced AI search results that model the human language.

In various embodiments, the disclosed generative machine learning framework allows AI services, including first party and third party services, to be easily integrated within cloud services. Each integrated AI service can be configured with custom and/or default configuration parameters to address different AI enhanced solutions and to optimize their respective results and performance. For example, different AI services can be configured with different hyperparameters including different trained LLMs and generative AI prompts to support context-specific solutions such as AI summarization and AI search. Moreover, additional post-AI service query checks can be integrated to ensure the appropriateness of the results provided by the integrated AI services. For example, content moderation, trustworthiness, and/or hallucination checks, among other checks, can be enabled for one or more of the integrated AI services where appropriate. In some embodiments, the disclosed framework includes preprocessing and postprocessing stages for tight integration of AI solutions on top of existing cloud services. For example, context-based searches can be implemented by integrating AI search functionality with existing cloud-based search services. An initial search can be performed on an internal repository to identify search results using internal context data to which the user has access. Instead of returning the internal context data as the search result, the identified context data is provided to an AI service to generate an AI enhanced search result in a human or natural language format.

In some embodiments, a framework for accessing one or more generative machine learning services is provided. For example, a framework used to construct digital workflows and/or to support cloud services is provided that allows AI services to be integrated with existing cloud services. In some embodiments, a specification of a desired solution associated with at least one of the one or more generative AI machine learning services is received. For example, the received specification can be triggered by a client-side and/or server-side action such as a user submission of an incident report that triggers a request for an incident report summarization. As another example, the completion of a chat conversation can trigger a request for a summary describing the conversation. As yet another example, a user can submit a search request that initiates an AI enhanced search query. An AI service is used to provide a search result to the user's search request using only the context of relevant knowledge articles from a local repository. In various embodiments, the triggered and/or initiated functionality is received with a specification of the desired solution. In some embodiments, the specification is preprocessed to generate a request in a second format of a selected generative machine learning service among the one or more generative machine learning services. For example, the specification can correspond to a specific AI service integrated within the framework using a specific configuration. The configuration can include preprocessing steps used to convert the cloud service request into a request format matching the AI service.

In some embodiments, a result of the selected generative machine learning service is received in response to the request. For example, in response to an AI service request, a result is received from the selected AI service. In some embodiments, the result of the selected generative machine learning service is postprocessed, wherein the preprocessing of the specification or the postprocessing of the result applies a configuration of the framework. For example, the framework configuration for the selected generative machine learning service is utilized to apply a postprocessing step so that the AI service result can be utilized by the cloud service. The result can include processing to convert the result into a format usable by the cloud service, such as a text summarization or search result format for display in a client user interface. In some embodiments, the postprocessing can include additional checks applied to the results such as applying content moderation to the AI result, confirming the trustworthiness of the result before using the result, and/or applying hallucination checks, for example, to test for incorrect or nonsensical AI results. In some embodiments, at least a portion of the postprocessed result is provided in response to the received specification of the desired solution. For example, a portion of the postprocessed AI service results is used for providing a cloud service response, such as a summarization of content or a search result using a natural language format.

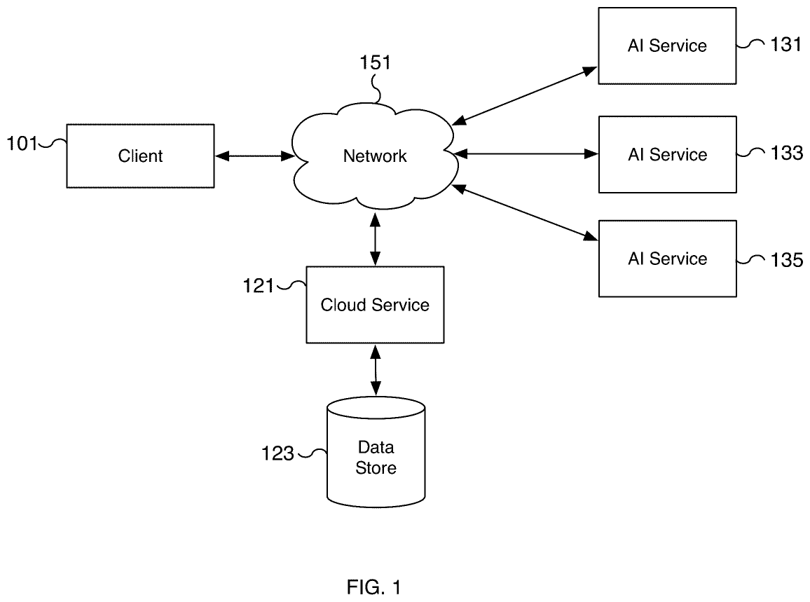

FIG. 1 is a block diagram illustrating an embodiment of a generative machine learning framework for integrating AI services. In the example shown, client 101 accesses one or more services hosted by cloud service 121 via network 151. Cloud service 121 utilizes data store 123 and includes a framework that integrates support for one or more AI Services such as AI Services 131, 133, and/or 135 that are connected to cloud service 121 via network 151. In some embodiments, client 101 is an administrative client used to manage and/or configure cloud service 121 to utilize AI Services 131, 133, and/or 135. Network 151 can be a public or private network. In some embodiments, network 151 is a public network such as the Internet. The services hosted by cloud service 121 can include a variety of cloud-based services including services for managing digital workflows for enterprise operations such as Information Technology ticketing, travel scheduling, and Human Resource processes, among others. AI services 131, 133, and/or 135 can offer a variety of advanced AI services including those based on generative AI and LLMs. For example, AI services 131, 133, and/or 135 can offer the ability to provide an AI summarization of provided text and/or an enhanced AI search result provided in a natural language format based on a provided local context. In various embodiments, AI services 131, 133, and/or 135 are accessed as stateless and/or stateful services and are implemented with their own machine learning servers, database servers, and/or other appropriate hardware.

In some embodiments, client 101 is a network client for accessing cloud service 121 and/or managing and/or administrating services of cloud service 121 that utilize AI services 131, 133, and/or 135. For example, using a web browser client, client 101 can access web services hosted by cloud service 121 such as an IT ticketing system to report IT incidents and to monitor their progress. In some embodiments, client 101 is a desktop computer, a laptop, a mobile device, a tablet, a kiosk, a voice assistant, a wearable device, or another network computing device. In various embodiments, client 101 can also be used to configure a service of cloud service 121 to utilize an AI result provided by AI services 131, 133, and/or 135. For example, client 101 can modify a digital IT ticketing workflow provided by cloud service 121 to provide an AI generated summary of an incident whenever an incident report is submitted. The AI generated summary can utilize AI services provided by AI services 131, 133, and/or 135.

In some embodiments, cloud service 121 offers cloud services including services for managing digital workflows. Example digital workflows include Software-as-a-Service (Saas) workflows for enterprise operations such as Information Technology ticketing, travel scheduling, and Human Resource processes, among others. In various embodiments, cloud service 121 includes a framework for creating, managing, and/or modifying the provided workflows. The disclosed framework is further a machine learning framework for integrating AI services such as the services offered by AI services 131, 133, and/or 135. For example, using client 101, an administrator can configure an AI service for integration into a service provided by cloud service 121. The configuration can include configuring custom and/or default AI service parameters such as machine learning hyperparameters to provide the desired and/or optimal AI result. As another example, the configuration can include configuring preprocessing and postprocessing steps to convert between protocol formats utilized by cloud service 121 and the AI services such as AI services 131, 133, and/or 135. Additional postprocessing steps can include integrating secondary checks on AI service results including checks on content moderation, trustworthiness, and hallucination. In some embodiments, cloud service 121 includes one or more servers and can include one or more distributed servers. Cloud service 121 can rely on a data store such as data store 123.

In some embodiments, data store 123 is utilized by cloud service 121 for storing and/or retrieving data for cloud services as well as for storing and/or retrieving data related to integrated AI services. For example, configurations of AI services 131, 133, and 135 can be stored at and retrieved from data store 123, including configuration parameters such as hyperparameters and additional checks to apply to AI service results. Data store 123 can also store data related to created workflows that utilize AI services 131, 133, and 135, such as configuration information for an AI summarization feature added to a virtual agent supported by cloud service 121. In some embodiments, data store 123 is implemented using one or more data stores such as one or more distributed data storage servers. For example, although shown as a single entity in FIG. 1, data store 123 can be implemented as one or more distributed data store components connected via network 151 to cloud service 121.

In some embodiments, AI services 131, 133, and 135 can include first and third party AI services. Each of AI services 131, 133, and 135 may utilize different protocols for performing AI requests to provide AI solutions. For example, each of AI services 131, 133, and 135 may utilize different network protocols and different request and result formats. The provided interface to AI services 131, 133, and 135 can be a stateless and/or stateful interface and the results provided via the interface (or application programming interface) can require postprocessing before they can be used by cloud service 121. Although each AI services 131, 133, and 135 is shown as a single entity, each can be a distributed service and each can be located in one or more different locations such as at different data centers.

Although single instances of some components have been shown to simplify the diagram of FIG. 1, additional instances of any of the components shown in FIG. 1 may exist. For example, cloud service 121, data store 123, and/or AI services 131, 133, and 135 may include one or more servers and/or may share servers. Furthermore, client 101 is just one example of a potential client to cloud service 121. Similarly, data store 123 may include one or more data store servers. In some embodiments, data store 123 may not be directly connected to cloud service 121. For example, data store 123 and its components may be replicated and/or distributed across multiple servers and/or components. In some embodiments, components not shown in FIG. 1 may also exist.

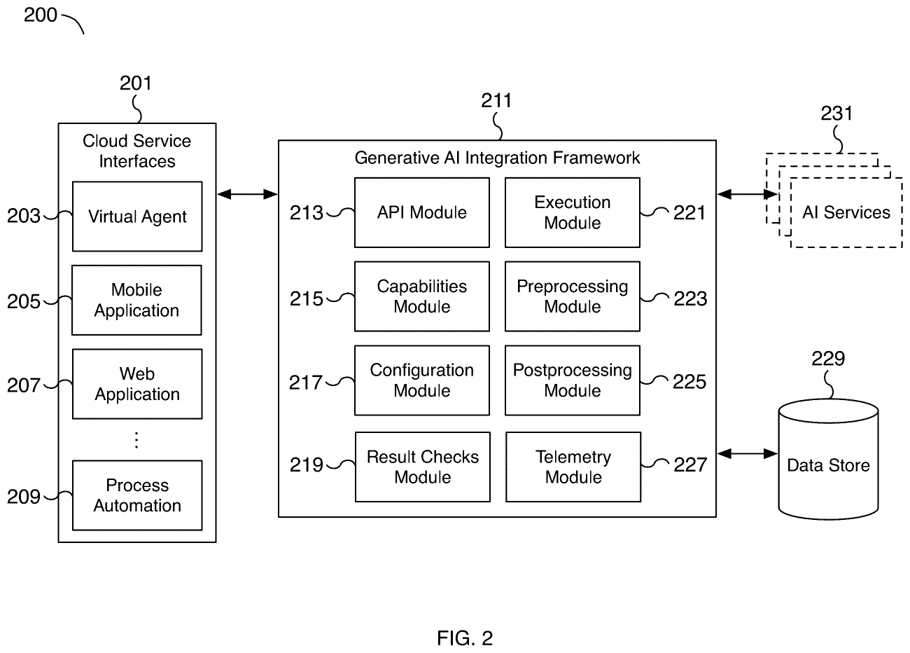

FIG. 2 is a block diagram illustrating an embodiment of a cloud service with a generative machine learning framework for integrating AI services. In the example shown, cloud service platform 200 includes cloud service interfaces 201, generative AI integration framework 211, data store 229, and AI services 231. Generative AI integration framework 211 is communicatively connected to cloud service interfaces 201, data store 229, and AI services 231. Cloud service interfaces 201 represent different interfaces for interacting with cloud services that support enhanced AI functionality supplied by AI services 231. Cloud service interfaces 201 can include client-side and/or server-side interfaces and include example interfaces virtual agent 203, mobile application 205, web application 207, and process automation 209. Generative AI integration framework 211 includes modules for integrating AI services including API module 213, capabilities module 215, configuration module 217, result checks module 219, execution module 221, preprocessing module 223, postprocessing module 225, and telemetry module 227. In some embodiments, cloud service platform 200 is cloud service 121 of FIG. 1 integrated with AI services 131, 133, and/or 135 of FIG. 1 and using data store 123 of FIG. 1. In some embodiments, one or more interfaces of cloud service interfaces 201 can be accessed by a client such as client 101 of FIG. 1, generative AI integration framework 211 is implemented as part of cloud service 121 of FIG. 1, data store 229 is data store 123 of FIG. 1, and AI services 231 is AI Services 131, 133, and/or 135 of FIG. 1.

In some embodiments, cloud service interfaces 201 are associated with one or more interfaces for accessing cloud services that utilize AI services 231. In the example shown, cloud service interfaces 201 include both user and headless interfaces and both client side and server side interfaces. For example, interfaces that correspond to user interfaces include client interfaces for virtual agent 203, mobile application 205, and web application 207. Each of virtual agent 203, mobile application 205, and web application 207 includes a client user interface for displaying results generated by AI services 231 by indirectly interfacing with AI services 231 via the cloud service. For example, virtual agent 203 can display AI summarization results of chat conversations at least in part generated by a request to AI services 231. Similarly, mobile application 205 and web application 207 can display AI summarization results such as a summarization of an incident when an incident is reported using mobile application 205 or web application 207 that is at least in part generated by a request to AI services 231. As another example, AI enhanced search results can be displayed using virtual agent 203, mobile application 205, and web application 207 in response to a search request submitted via virtual agent 203, mobile application 205, or web application 207. In addition to user interfaces, process automation 209 is an example of a headless interface and corresponds to an automation of a digital process. The automation of process automation 209 can be run without a client user interface but still utilizes an interface, such as an application programming interface (API), for submitting a request for AI services via the cloud service. For example, process automation 209 can request an AI summary of a description for a completed task executed by process automation 209. In various embodiments, each of the interfaces of cloud service interfaces 201 utilizes an interface, such as an API, for requesting AI-based services from the cloud service. For example, each interface can rely on a different underlying protocol and/or an API such as a Java, a scripting language, a REST, or another protocol, API, or interface.

In some embodiments, generative AI integration framework 211 includes multiple modules to support integrating AI services 231. Although the modules are described with respect to their module's functionality, one or more of the modules may be combined and/or additional modules may be utilized to perform the described functionality. In various embodiments, API module 213 is an embodiment of a functional module for allowing cloud service interfaces 201 to interface using a known format and/or protocol in order to access AI services 231. For example, using API module 213, cloud service interfaces 201 can utilize an existing cloud service interface such as a Java or REST API to access AI enhanced results. The provided APIs of API module 213 can be AI service independent allowing the underlying AI service to be easily swapped without changing the integration logic layer. In some embodiments, capabilities module 215 is a functional module for defining the functionality of an AI service. Using capabilities module 215, the capabilities and corresponding interface protocol of an AI service can be defined. Cloud solutions that then utilize the AI service can target the defined capabilities. In various embodiments, configuration module 217 is a functional module for configuring solutions that utilize an integrated AI service. The configuration module allows an administrator to target an integrated AI service and provide corresponding configuration parameters when the selected AI service is requested. For example, hyperparameters including a specific model, temperature, and token parameters can be configured. Similarly, parameters for an epoch number, a batch size, and/or a learning rate multiplier can be configured, if appropriate. In some embodiments, configuration module 217 is used to configure checks that are applied to the AI service request such as content moderation, trustworthiness, and hallucination checks.

In various embodiments, the configured result checks are implemented by result checks module 219. For example, one or more implementations of a result check can be supported by result checks module 219 and, if enabled, are applied to the results returned from an AI service. In some embodiments, a content moderation check scans the AI results for configured inappropriate content such as profanity. Similarly, a trustworthiness check can be implemented to check the trustworthiness of the results and a hallucination check can be used, for example, to test for incorrect or nonsensical AI results. In some embodiments, execution module 221 is a functional module for executing an AI service request. Execution module 221 can execute the AI service request using the required network protocols of the integrated and selected AI service. In some embodiments, execution module 221 further receives the response to the AI request that is returned in response to sending the request. The request may be a blocking or non-blocking request.

In the example shown, generative AI integration framework 211 includes preprocessing module 223 and postprocessing module 225 for the preprocessing and postprocessing of the AI service request and corresponding response, respectively. For example, preprocessing module 223 can apply preprocessing to the request provided via cloud service interfaces 201 to convert the AI service request to the format required by the selected AI service. In various embodiments, postprocessing module 225 applies corresponding postprocessing to the AI service result. The postprocessing applied can convert the result of the AI response from a format of the selected AI service to the format required by the cloud service and requesting interface of cloud service interfaces 201. In some embodiments, postprocessing module 225 further initiates any checks enabled for the AI result using result checks module 219. In various embodiments, preprocessing module 223 and/or postprocessing module 225 can utilize the configuration parameters and the capabilities definition of the selected AI service set using capabilities module 215 and configuration module 217, respectively, to perform the appropriate configured processing.

In various embodiments, telemetry module 227 is a functional module for performing telemetry on AI service requests. For example, telemetry module 227 can be utilized to enable instrumentation of the AI service requests to collect usage data including payload and token usage. In various embodiments, usage data from cloud service interfaces 201 and/or the selected AI service is collected and logged using telemetry module 227. In some embodiments, telemetry module 227 can further be used to export collected telemetry data, for example, via an administrative interactive user interface dashboard.

In some embodiments, in the context of FIG. 2, data store 229 is utilized by cloud service platform 200 and in particular by generative AI integration framework 211 to store integration and customization parameters for AI services 231. For example, data store 229 can be utilized to store parameters, protocol conversion steps, additional AI result checks, and other AI service integration data. In various embodiments, data store 229 can be a distributed data store and can be implemented as one or more distributed data stores.

In some embodiments, AI services 231 are AI services including first or third party services. The various services of AI services 231 can be accessed via their respective interfaces such as via their respective APIs. Moreover, each service of AI services 231 can require different configuration parameters, such as different hyperparameters and different values for the parameters to generate the optimal and/or desired result. The services of AI services 231 are shown with dotted outlines and with multiple instances to reflect that the services of AI services 231 can be independent of one another. In various embodiments, generative AI integration framework 211 is utilized to integrate the services offered by AI services 231 with the services offered by cloud service platform 200.

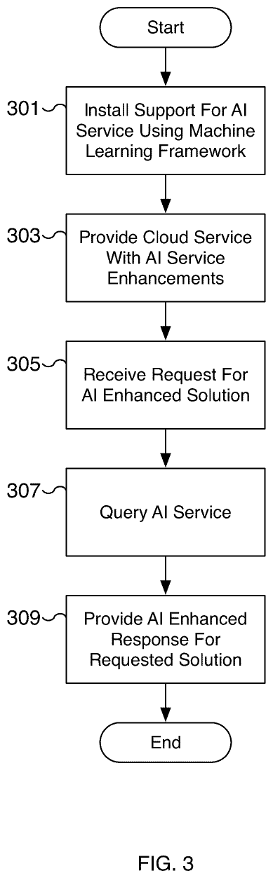

FIG. 3 is a flow chart illustrating an embodiment of a process for integrating AI services with a cloud service using a machine learning framework. For example, using the process of FIG. 3, an AI service is integrated with cloud services using a machine learning framework of the cloud service. Once integrated, existing and new services provided by the cloud service can utilize the integrated AI service, for example, to provide results enhanced by the AI service such as AI summarization and AI search results. In various embodiments, the integrated AI services include generative AI functionality utilizing LLMs. By integrating an AI service for use with the cloud service, users of the cloud service are provided with access to the integrated AI service via a provider independent interface including access with no-code and/or low-code AI solutions. AI service integration further allows for implementation versioning and quick adoption of new AI service providers without impacting existing AI service integrations. In some embodiments, the process of FIG. 3 is implemented by a cloud service such as cloud service 121 of FIG. 1 and/or cloud service 200 of FIG. 2. In some embodiments, the integration process utilizes a generative AI integration framework such as generative AI integration framework 211 of FIG. 2. In some embodiments, the integrated AI service is an AI service such as AI services 131, 133, and/or 135 of FIG. 1 and/or an AI service of AI services 231 of FIG. 2.

At 301, support for an AI service is installed using a machine learning framework. For example, an AI service such as a first party or third party AI service is configured using the machine learning framework of the cloud service. The installation process can include creating an AI service definition for the capabilities of the AI service and providing configuration parameters for different use cases or AI solutions for the AI service. For example, a capabilities module of the machine learning framework can be utilized to define the AI service including its interfaces and required formats and a configuration module of the machine learning framework can be utilized to create configuration profiles for each use case for the AI service. In some embodiments, the capabilities module is capabilities module 215 of FIG. 2 and/or the configuration module is configuration module 217 of FIG. 2. In some embodiments, an API module of the machine learning framework is updated to expose an AI service independent API to access features of the installed AI service. In some embodiments, the API module is API module 213 of FIG. 2.

At 303, a cloud service with AI service enhancements is provided. For example, a cloud service that utilizes the installed AI service to provide enhanced AI results is provided. In some embodiments, the AI enhanced service is accessed via a client user interface such as a virtual agent, a mobile application, and/or a web application. The AI enhanced service can also be a headless service with no corresponding user interface such as an automation or automated process. Examples of AI enhanced services include AI services that provide an AI generated summary, AI search results, and/or AI provided results in a natural language format.

At 305, a request for an AI enhanced solution is received. For example, a request initiated by a user, a process such as an automated process, or another trigger for an AI enhanced solution is received. The request is received using an interface that is independent of any specific AI service such as a cloud service API and then converted to a format used by the selected AI service.

At 307, an AI service is queried. For example, the selected AI service for the requested AI enhanced solution is queried using a version of the request in the format of the selected AI service. In various embodiments, the request may be preprocessed at step 305 and/or 307 to prepare the request for the AI service. In response to the AI service query, an AI service response is received with an AI service result. In various embodiments, postprocessing is applied to the AI service result. The postprocessing can include a conversion from a format used by the AI service to an interface format used by the cloud service. Postprocessing can further include applying additional checks to the AI service result such as content moderation, trustworthiness, and/or hallucination checks.

At 309, an AI enhanced response for the requested solution is provided. For example, an AI enhanced response such as an AI search or an AI summarization is created by postprocessing the AI service result at 307 into a format used by the cloud service. In various embodiments, the generated AI enhanced response is provided as the requested AI solution. In some embodiments, the response is provided to a client such as an AI generated summary of a chat conversation provided via a client virtual agent user interface. In some embodiments, the response is provided without immediate client visibility or a client user interface such as an AI generated summary of an incident that is stored in a data store of the cloud service as part of generating a daily summary of outstanding incidents. In various embodiments, the provided AI enhanced response is platform independent of the AI service.

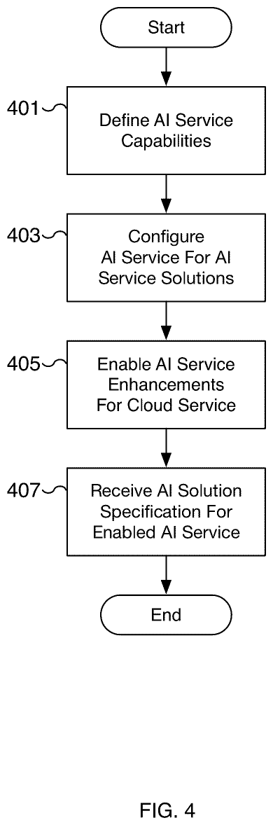

FIG. 4 is a flow chart illustrating an embodiment of a process for installing support for an AI service using a machine learning framework. For example, using the process of FIG. 4, an AI service is integrated with cloud services using a machine learning framework of the cloud service. Once integrated, existing and new services provided by the cloud service can utilize the integrated AI service, for example, to provide results enhanced by the AI service such as AI summarization and AI search results. In some embodiments, the process of FIG. 4 is performed at 301 of FIG. 3. In some embodiments, the process of FIG. 4 is implemented by a cloud service such as cloud service 121 of FIG. 1 and/or cloud service 200 of FIG. 2. In some embodiments, the integration process utilizes a generative AI integration framework such as generative AI integration framework 211 of FIG. 2. In some embodiments, the integrated AI service is an AI service such as AI services 131, 133, and/or 135 of FIG. 1 and/or an AI service of AI services 231 of FIG. 2.

At 401, the capabilities of an AI service are defined. For example, the capabilities of a new AI service are defined. In some embodiments, the definition of the capabilities for the new AI service includes describing and/or enumerating the parameters required for utilizing the AI service and/or the protocol and/or format used by the new AI service. In some embodiments, the definition can include required and optional parameters and the corresponding capabilities offered when the appropriate parameters are set. In various embodiments, the defined capabilities can be used for preprocessing and postprocessing steps to convert between the AI service independent interface used by the cloud service and the specific interface required by the new AI service for AI service requests and corresponding AI service responses.

At 403, the AI service is configured for AI service solutions. For example, one or more configurations for the AI service are provided. In various embodiments, each provided configuration for an integrated AI service can correspond to a different AI solution that uses the selected AI service. Each provided configuration can include a set of configuration parameters including hyperparameter values. For example, a specific model and/or version of a model can be provided as well as a temperature parameter and/or token parameters including a maximum token parameter. In some embodiments, the parameters include parameters for configuring an epoch number, a batch size, and/or a learning rate multiplier. In various embodiments, the configuration for an AI service can include a prompt configuration such as a prompt template that can be applied for generative AI responses using an LLM.

At 405, AI service enhancements are enabled for the cloud service. For example, the AI solutions configured using the installed AI service are enabled for use by the cloud service. In some embodiments, the enabled AI service enhancements can be integrated into existing cloud services using no-code and/or low-code user interfaces. For example, cloud service for creating and offering digital workflows can provide a user interface for adding AI summarization and/or AI search functionality using a no-code and/or low-code techniques.

At 407, an AI solution specification for an enabled AI service is received. For example, in response to a request to use an AI solution provided by an integrated AI service, an AI solution specification for the AI solution is received. In various embodiments, the AI solution specification can be used to trigger the execution of a request for the configured AI solution. In various embodiments, the specification is utilized by the cloud service to enhance results using an AI service solution configured at 403 and enabled at 405. For example, a virtual agent implementation can include in its workflow the AI solution specification to trigger creating an AI generated summary when a chat conversation with an IT incident agent is finished.

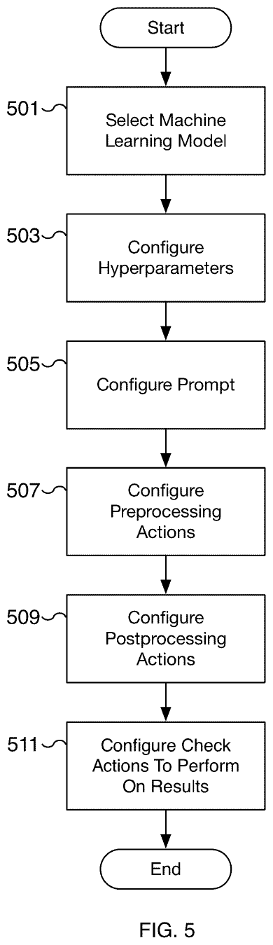

FIG. 5 is a flow chart illustrating an embodiment of a process for configuring an AI service to support AI service solutions. For example, using the process of FIG. 5, an AI service integrated with a cloud service using a machine learning framework of the cloud service is configured to offer AI service solutions as part of the cloud service. The configured AI service solutions can be utilized in existing and new services provided by the cloud service, for example, to provide results enhanced by an AI service solution such as an AI summarization solution and an AI search result solution. In some embodiments, the process of FIG. 5 is performed at 301 of FIG. 3 and/or at 403 of FIG. 4. In some embodiments, the process of FIG. 5 is implemented by a cloud service such as cloud service 121 of FIG. 1 and/or cloud service 200 of FIG. 2. In some embodiments, the AI service configuration process utilizes a generative AI integration framework such as generative AI integration framework 211 of FIG. 2. In some embodiments, the integrated AI service is an AI service such as AI services 131, 133, and/or 135 of FIG. 1 and/or an AI service of AI services 231 of FIG. 2.

At 501, a machine learning model is selected. In some embodiments, the model is an LLM or trained large language model. For example, the model including the version of the model can be selected based on the desired AI solution results. In various embodiments, different models can be trained and optimized for different types of AI solutions. At 501, the appropriate model is selected for the desired AI service solution. In some embodiments, the model is selected by providing a model unique identifier.

At 503, hyperparameters are configured. For example, at 503, the hyperparameters for the model selected at 501 are configured. In some embodiments, default and/or custom hyperparameters are provided to tune the prediction results of the selected trained machine learning model. In some embodiments, hyperparameters to select the model are configured at 501 and additional hyperparameters are configured at 503. In various embodiments, the hyperparameters configured include parameters corresponding to a temperature parameter and token parameters such as a maximum token parameter. In some embodiments, the hyperparameters configured include parameters corresponding to an epoch number, a batch size, and/or a learning rate multiplier, among other hyperparameters.

At 505, a prompt is configured. For example, a prompt for interfacing with a selected AI service, such as with a generative AI service utilizing the LLM selected at 501 is configured. In some embodiments, the prompt is configured as a prompt template. Using the configured prompt template, a prompt can be generated using predefined text portions of the prompt and dynamic portions of the prompt where the dynamic portions can change based on the specific AI request and/or context of the AI request. In various embodiments, the configured prompt is used to construct an AI service request when an AI solution is desired. In some embodiments, the prompt configuration is used to generate a prompt in a natural language format.

At 507, preprocessing actions are configured. For example, one or more preprocessing actions or steps are configured for the AI service solution. The preprocessing actions can include conversion actions to convert from a platform independent format used to interface with the cloud service to a specific AI service format used by the selected AI service. In some embodiments, the preprocessing includes preprocessing and/or determining the appropriate context data. For example, a local repository can be searched for the appropriate local context to include with the AI service request as part of a preprocessing step.

At 509, postprocessing actions are configured. For example, one or more postprocessing actions or steps are configured for the AI service solution. The postprocessing actions can include conversion actions to convert from a specific AI service format used by the selected AI service to a platform independent format used to interface with the cloud service. The conversion can be required to provide the AI service results in a format usable by the cloud service.

At 511, check actions to perform on results are configured. For example, one or more additional or post AI service query checks to perform on the AI service results are configured. These secondary checks can be applied to ensure that the AI service results conform to the required expectations and/or standards. For example, a content moderation check can be configured to ensure that the AI service results conform to content standards. In some embodiments, the content moderation check can remove profanity and/or other filtered words and/or phrases from the AI service results and/or trigger a notification that an AI service result has exceeded a content moderation allowance threshold. In various embodiments, additional check actions can include a trustworthiness check and/or hallucination checks. For example, a generative AI hallucination check tests the AI response for incorrect or nonsensical results.

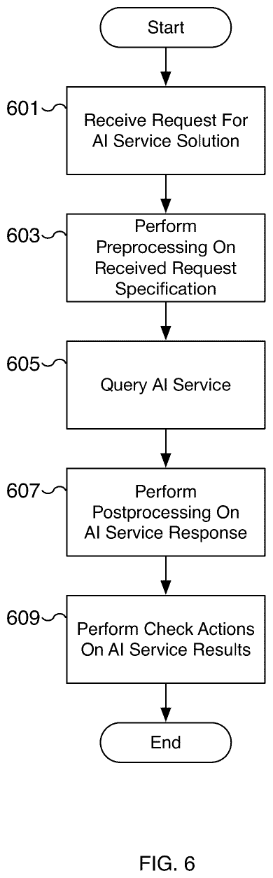

FIG. 6 is a flow chart illustrating an embodiment of a process for providing an AI enhanced solution for a cloud service request. For example, using the process of FIG. 6, an AI service integrated with a cloud service is queried for an AI service solution. The selected AI service for providing the AI enhanced solution is accessed using a machine learning framework of the cloud service. In some embodiments, the process of FIG. 6 is performed at 305, 307, and/or 309 of FIG. 3. In some embodiments, the process of FIG. 6 is implemented by a cloud service such as cloud service 121 of FIG. 1 and/or cloud service 200 of FIG. 2. In some embodiments, the AI solution is processed using a generative AI integration framework such as generative AI integration framework 211 of FIG. 2. In some embodiments, the AI service providing the AI solution is an AI service such as AI services 131, 133, and/or 135 of FIG. 1 and/or an AI service of AI services 231 of FIG. 2.

At 601, a request for an AI service solution is received. For example, a request is received that specifies a particular AI service solution such as an AI summarization or AI search using a selected AI service. The request can include context to utilize for the AI service solution such as context data for summarization or for searching. In some embodiments, the specification for the request includes configuration parameters for the selected AI service based on the configuration for the AI solution.

At 603, preprocessing is performed on the received request specification. For example, the request is preprocessed to generate an AI service request in the format required by the selected AI service. In various embodiments, the preprocessing can include formatting the request and supplying configuration parameters including hyperparameters for the selected AI service. For example, an AI service request is generated in the native format required by the AI service using the capabilities defined for the AI service. In particular embodiments, the formatted request includes context data such as context data to summarize and/or context data such as local documents to search.

At 605, the AI service is queried. For example, the AI service is queried using the request formatted at 603 specifically for the selected AI service. The AI service query can be a blocking or non-blocking network request. In various embodiments, a response is received in the format and/or protocol of the AI service.

At 607, postprocessing is performed on the AI service response. For example, the AI response is converted from the format utilized by the AI service to an AI service independent format and AI service result used by the cloud service. In various embodiments, postprocessing can extract the relevant and/or desired fields from the AI service response to create an AI service result. In some embodiments, the postprocessing step is used to initiate the enabled check actions performed at 609.

At 609, check actions are performed on the AI service results. For example, the AI results are analyzed by applying one or more configured check actions. Example checks can include a content moderation check, a trustworthiness check, and a hallucination check, among other checks. In some embodiments, the check actions are applied as part of the postprocessing step of 607.

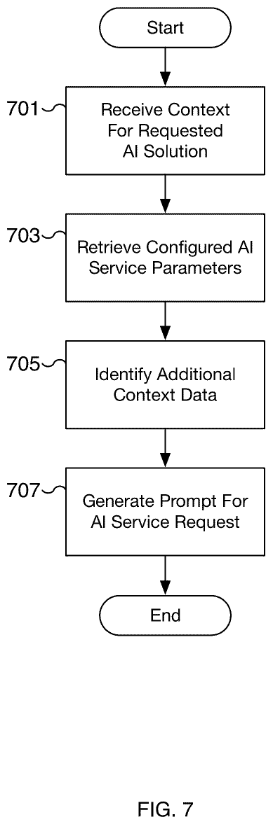

FIG. 7 is a flow chart illustrating an embodiment of a process for requesting an AI enhanced solution using local context data. For example, using the process of FIG. 7, an AI service integrated with a cloud service is queried for an AI service solution result using local context data. For example, an AI search can be performed using an integrated AI service on local context data to return a result from the selected AI service in a natural language format. The selected AI service for providing the AI enhanced solution is accessed using a machine learning framework of the cloud service. In some embodiments, the process of FIG. 7 is performed at 305, 307, and/or 309 of FIG. 3 and/or at 603 and/or 605 of FIG. 6. In some embodiments, the process of FIG. 7 is implemented by a cloud service such as cloud service 121 of FIG. 1 and/or cloud service 200 of FIG. 2. In some embodiments, the AI solution is processed using a generative AI integration framework such as generative AI integration framework 211 of FIG. 2. In some embodiments, the AI service providing the AI solution is an AI service such as AI services 131, 133, and/or 135 of FIG. 1 and/or an AI service of AI services 231 of FIG. 2.

At 701, context for the requested AI solution is received. For example, a specification describes the requested AI solution and includes relevant context information for initiating an AI service request. The provided context at 701 can include chat conversations and/or user provided data such as a search query. In some embodiments, the requested AI solution requires additional local context data in order to generate a useful AI service result. For example, an AI search summary of a local repository will include in the context received at 701 a search query but not the local context data from the local repository on which the selected AI service should perform an AI search summary.

At 703, configured AI service parameters are retrieved. For example, using the specification of the context received at 701, configuration parameters for the AI solution are retrieved. The retrieved configured AI service parameters can include hyperparameters including a trained machine learning model identifier among other hyperparameters. Additional retrieved parameters can include the format and/or protocol requirements for sending an AI service query.

At 705, additional context data is identified. For example, additional context data as required by the requested AI solution received at 701 is identified. The additional context data can be provided by the cloud service and/or specifically at least in part by a preprocessing module of a machine learning framework of the cloud service. For example, for an AI search summary, the additional context data can include the local search result data matching a provided search query. In some embodiments, for an AI search summary, an internal repository is searched to identify internal context data, such as internal knowledge articles. The matching internal context data is provided as additional context data for the AI service on which to perform an AI search summary. As part of the requested AI solution, the AI service will summarize the results of searching the provided internal context data using the provided search query. By providing internal context data, the requested AI solution results can be confined to only the data accessible by the user associated with the requested AI solution.

At 707, a prompt for the AI service request is generated. For example, using a prompt configuration for the AI solution, a prompt that includes the context received at 701 and additional context data identified at 705 is generated. In some embodiments, the prompt is generated using a prompt template. For example, the prompt template can include predefined text portions and dynamic portions. In generating the prompt, the dynamic portions are replaced with the values of the context data. In various embodiments, the generated prompt is formatted using the prompt format required by the selected AI service.

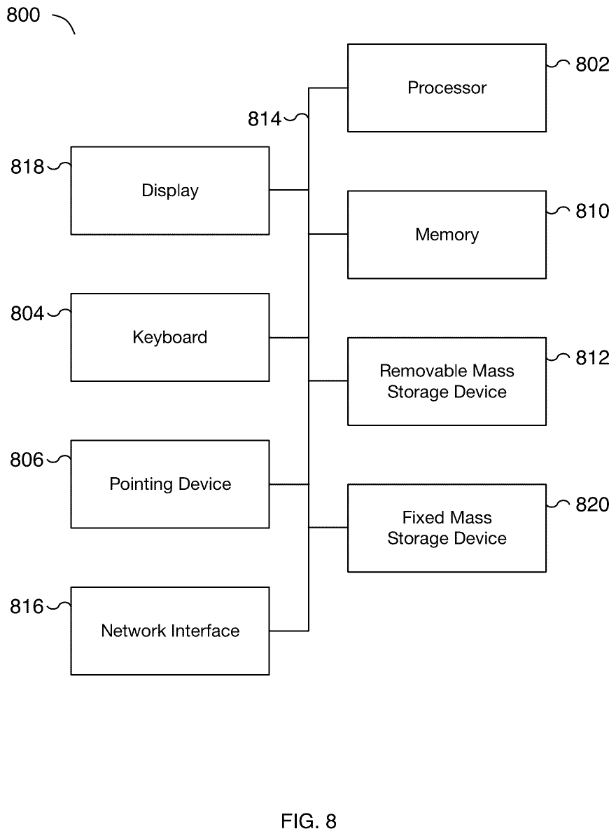

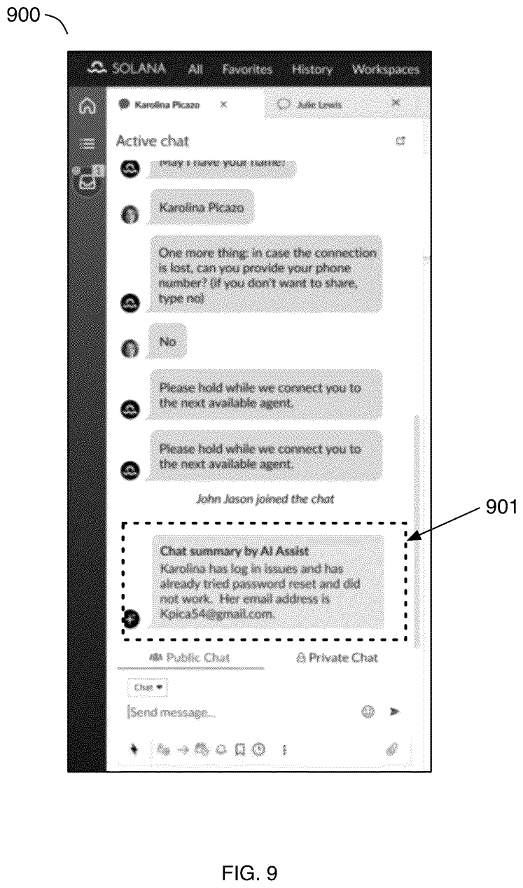

FIG. 8 is a functional diagram illustrating a programmed computer system for a generative machine learning framework for integrating AI services. As will be apparent, other computer system architectures and configurations can be utilized for providing an integrated generative machine learning framework used to integrate AI services. Examples of computer system 800 include client 101 of FIG. 1, one or more computers of cloud service 121 of FIG. 1, one or more computers of data store 123 of FIG. 1, one or more computers of AI Services 131, 133, and 135 of FIG. 1, and/or one or more computers of cloud service 200 of FIG. 2. Computer system 800, which includes various subsystems as described below, includes at least one microprocessor subsystem (also referred to as a processor or a central processing unit (CPU)) 802. For example, processor 802 can be implemented by a single-chip processor or by multiple processors. In some embodiments, processor 802 is a general purpose digital processor that controls the operation of the computer system 800. Using instructions retrieved from memory 810, the processor 802 controls the reception and manipulation of input data, and the output and display of data on output devices (e.g., display 818). In various embodiments, one or more instances of computer system 800 can be used to implement at least portions of the processes of FIGS. 3-7 and the user interface of FIG. 9.

Processor 802 is coupled bi-directionally with memory 810, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also as is well known in the art, primary storage typically includes basic operating instructions, program code, data and objects used by the processor 802 to perform its functions (e.g., programmed instructions). For example, memory 810 can include any suitable computer-readable storage media, described below, depending on whether, for example, data access needs to be bi-directional or unidirectional. For example, processor 802 can also directly and very rapidly retrieve and store frequently needed data in a cache memory (not shown).

A removable mass storage device 812 provides additional data storage capacity for the computer system 800, and is coupled either bi-directionally (read/write) or unidirectionally (read only) to processor 802. For example, storage 812 can also include computer-readable media such as magnetic tape, flash memory, PC-CARDS, portable mass storage devices, holographic storage devices, and other storage devices. A fixed mass storage 820 can also, for example, provide additional data storage capacity. The most common example of mass storage 820 is a hard disk drive. Mass storages 812, 820 generally store additional programming instructions, data, and the like that typically are not in active use by the processor 802. It will be appreciated that the information retained within mass storages 812 and 820 can be incorporated, if needed, in standard fashion as part of memory 810 (e.g., RAM) as virtual memory.

In addition to providing processor 802 access to storage subsystems, bus 814 can also be used to provide access to other subsystems and devices. As shown, these can include a display monitor 818, a network interface 816, a keyboard 804, and a pointing device 806, as well as an auxiliary input/output device interface, a sound card, speakers, and other subsystems as needed. For example, the pointing device 806 can be a mouse, stylus, track ball, or tablet, and is useful for interacting with a graphical user interface.

The network interface 816 allows processor 802 to be coupled to another computer, computer network, or telecommunications network using a network connection as shown. For example, through the network interface 816, the processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect the computer system 800 to an external network and transfer data according to standard protocols. For example, various process embodiments disclosed herein can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

An auxiliary I/O device interface (not shown) can be used in conjunction with computer system 800. The auxiliary I/O device interface can include general and customized interfaces that allow the processor 802 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 8 is but an example of a computer system suitable for use with the various embodiments disclosed herein. Other computer systems suitable for such use can include additional or fewer subsystems. In addition, bus 814 is illustrative of any interconnection scheme serving to link the subsystems. Other computer architectures having different configurations of subsystems can also be utilized.

FIG. 9 is a diagram illustrating an embodiment of a user interface for a virtual agent cloud service integrated with an AI service using a generative machine learning framework. In the example shown, user interface 900 is a client user interface for hosting chat conversations with a virtual agent. The functionality of the virtual agent is enhanced with AI summarization solution 901 provided by an integrated AI service. The virtual agent client can utilize a cloud service interface such as the interface associated with virtual agent 203 of FIG. 2 to request an AI summarization solution. In some embodiments, the functionality of the virtual agent is hosted by a cloud service such as cloud service 121 of FIG. 1 and/or cloud service 200 of FIG. 2 and the utilized AI service is AI services 131, 133, and/or 135 of FIG. 1 and/or an AI service of AI services 231 of FIG. 2. In some embodiments, the AI service is integrated with the cloud service using a generative AI integration framework such as generative AI integration framework 211 of FIG. 2. In various embodiments, the AI solution shown in user interface 900 is provided using the processes of FIGS. 3-7.

As shown in FIG. 9, user interface 900 includes a chat conversation with a virtual agent. At the completion of the chat conversation, a visual representation of AI summarization solution 901 is provided. AI summarization solution 901 is generated by an AI service configured to provide AI summarizations. In the example shown, AI summarization solution 901 includes an AI generated summary of the chat conversation between the user and the virtual agent. AI summarization solution 901 includes the heading “Chat summary by AI Assist” followed with a summary of the chat conversation generated by the selected AI service associated with a specific configured AI summarization solution. In various embodiments, the request to the AI service for the AI solution provides a specification of the requested AI solution including the chat conversation context, such as the text contents of the chat bubbles, their corresponding authors, and their relative sequence in time. In response to an AI service request, the selected AI service applies generated AI prediction using an LLM to generate a summary of the chat conversation that includes only the most relevant and useful details. The provided summary of AI summarization solution 901 is provide using a natural language format.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
providing a framework for accessing one or more generative machine learning services;
receiving in a first format of the framework, a specification of a desired solution associated with at least one of the one or more generative machine learning services;
preprocessing the specification to generate a request in a second format of a selected generative machine learning service among the one or more generative machine learning services;
receiving a result of the selected generative machine learning service in response to the request;
postprocessing the result of the selected generative machine learning service, wherein the preprocessing of the specification or the postprocessing of the result applies a configuration of the framework; and
providing at least a portion of the postprocessed result in response to the received specification of the desired solution.

2. The method of claim 1, wherein the preprocessing the specification includes searching an internal repository to identify internal context data for the desired solution and including at least a portion of the internal context data in the request in the second format.

3. The method of claim 1, further comprising performing one or more checks on the result of the selected generative machine learning service, wherein the one or more checks include a content moderation check, a trustworthiness check, or a hallucination check.

4. The method of claim 1, further comprising receiving the configuration of the framework, wherein the configuration includes configuration parameters for the selected generative machine learning service.

5. The method of claim 4, wherein the configuration parameters for the selected generative machine learning service includes machine learning hyperparameters.

6. The method of claim 5, wherein the machine learning hyperparameters include a model identifier parameter, a temperature parameter, or a maximum token parameter.

7. The method of claim 6, wherein the model identifier parameter corresponds to a machine learning model trained to generate results in a human language.

8. The method of claim 5, wherein the machine learning hyperparameters include an epoch number, a batch size, or a learning rate multiplier.

9. The method of claim 4, wherein the preprocessing the specification to generate the request in the second format of the selected generative machine learning service among the one or more generative machine learning services includes generating a prompt based on a prompt configuration parameter for the selected generative machine learning service.

10. The method of claim 1, wherein the desired solution includes a summarization of two or more text-based input sources.

11. A system comprising:
one or more processors; and
a memory coupled to the one or more processors, wherein the memory is configured to provide the one or more processors with instructions which when executed cause the one or more processors to:
provide a framework for accessing one or more generative machine learning services;
receive in a first format of the framework, a specification of a desired solution associated with at least one of the one or more generative machine learning services;
preprocess the specification to generate a request in a second format of a selected generative machine learning service among the one or more generative machine learning services;
receive a result of the selected generative machine learning service in response to the request;
postprocess the result of the selected generative machine learning service, wherein the preprocessing of the specification or the postprocessing of the result applies a configuration of the framework; and
provide at least a portion of the postprocessed result in response to the received specification of the desired solution.

12. The system of claim 11, wherein the preprocessing the specification includes searching an internal repository to identify internal context data for the desired solution and including at least a portion of the internal context data in the request in the second format.

13. The system of claim 11, wherein the memory is further configured to provide the one or more processors with instructions which when executed cause the one or more processors to perform one or more checks on the result of the selected generative machine learning service, wherein the one or more checks include a content moderation check, a trustworthiness check, or a hallucination check.

14. The system of claim 11, wherein the memory is further configured to provide the one or more processors with instructions which when executed cause the one or more processors to receive the configuration of the framework, wherein the configuration includes configuration parameters for the selected generative machine learning service.

15. The system of claim 14, wherein the configuration parameters for the selected generative machine learning service includes machine learning hyperparameters.

16. The system of claim 15, wherein the machine learning hyperparameters include a model identifier parameter, a temperature parameter, or a maximum token parameter.

17. The system of claim 16, wherein the model identifier parameter corresponds to a machine learning model trained to generate results in a human language.

18. The system of claim 15, wherein the machine learning hyperparameters include an epoch number, a batch size, or a learning rate multiplier.

19. The system of claim 14, wherein the preprocessing the specification to generate the request in the second format of the selected generative machine learning service among the one or more generative machine learning services includes generating a prompt based on a prompt configuration parameter for the selected generative machine learning service.

20. A computer program product, the computer program product being embodied in a non-transitory computer readable storage medium and comprising computer instructions for:
providing a framework for accessing one or more generative machine learning services;
receiving in a first format of the framework, a specification of a desired solution associated with at least one of the one or more generative machine learning services;
preprocessing the specification to generate a request in a second format of a selected generative machine learning service among the one or more generative machine learning services;
receiving a result of the selected generative machine learning service in response to the request;
postprocessing the result of the selected generative machine learning service, wherein the preprocessing of the specification or the postprocessing of the result applies a configuration of the framework; and
providing at least a portion of the postprocessed result in response to the received specification of the desired solution.
